(19) United States
(12) Patent Application Publication
(10) Pub. No.: US 2017/0020089 A1
(43) Pub. Date: Jan. 26, 2017

(54) SYSTEMS, METHODS, AND DEVICES FOR DYNAMIC IRRIGATION WITH USER ADJUSTED CONTROL

(71) Applicant: Skydrop Holdings, LLC, Highland, UT (US)

(72) Inventors: Clark Endrizzi, Sandy, UT (US); Matt Romney, Alpine, UT (US); Mack Dalley, Alpine, UT (US); Robert Mars, Superior, CO (US)

(73) Assignee: Skydrop Holdings, LLC, Highland, UT (US)

(21) Appl. No.: 15/069,798

(22) Filed: Mar. 14, 2016

Related U.S. Application Data
(60) Provisional application No. 62/133,361, filed on Mar. 14, 2015.

(51) Int. Cl. A01G 25/16; G05B 19/042; A01G 25/02

(52) U.S. Cl. CPC A01G 25/165; A01G 25/167; A01G 25/02; G05B 19/042; G05B 2219/2625; G05B 2219/25419

(57) ABSTRACT

A method for determining watering times includes determining a dynamic watering schedule to replenish water in a root zone for an irrigation zone. The method includes controlling an irrigation system to water the irrigation zone based on the dynamic watering schedule. The method includes, in response to irrigation of the irrigation zone according to the dynamic watering schedule, receiving user input indicating a preference to increase or decrease wetness for the irrigation zone. The method includes, in response to the user input, modifying the dynamic watering schedule based on the user input to increase or decrease wet. The method further includes controlling the irrigation system to water the irrigation zone based on the dynamic watering scheduled as modified.

### RELATED APPLICATION

This application claims the benefit under 35 U.S.C. §119(e) of U.S. Provisional Application No. 62/133,361, filed Mar. 14, 2015 with a docket number SKY-0041.PO, which is hereby incorporated by reference herein in its entirety.

### TECHNICAL FIELD

The present disclosure relates to irrigation control and more particularly relates to dynamic irrigation protocols with user adjusted controls.

### BRIEF DESCRIPTION OF THE DRAWINGS

FIG. 1 illustrates an overhead view of a landscaped yard surrounding a house with a zoned irrigation system in accordance with the teachings and principles of the disclosure;

FIG. 2 illustrates a schematic diagram of an optimized irrigation control system that communicates over a network in accordance with the teachings and principles of the disclosure;

FIG. 3 illustrates a schematic diagram of a pairing between a control unit and an account in accordance with the teachings and principles of the disclosure;

FIG. 4 illustrates a schematic diagram of a pairing between a control unit and an account in accordance with the teachings and principles of the disclosure;

FIG. 5 illustrates a method for initiating an irrigation optimization system in accordance with the teachings and principles of the disclosure;

FIG. 6 illustrates a method of initiating a smart irrigation system in accordance with the teachings and principles of the disclosure;

FIG. 7 illustrates a schematic diagram of a database and protocol generator in accordance with the teachings and principles of the disclosure;

FIG. 8 illustrates a block diagram of an exemplary method for optimizing irrigation by adjusting duration in accordance with the teachings and principles of the disclosure;

FIG. 9 is a schematic of an irrigation server running a protocol generator in accordance with the teachings and principles of the disclosure;

FIG. 10 illustrates an implementation of a method for providing user adjustability of irrigation protocols in accordance with the teachings and principles of the disclosure;

FIG. 11 illustrates a schematic of a user interface in accordance with the teachings and principles of the disclosure;

FIG. 12 is a schematic block diagram illustrating an irrigation schedule control system in accordance with the teachings and principles of the disclosure;

FIG. 13 is a schematic flow chart diagram illustrating a method for determining a watering scheduled in accordance with the teachings and principles of the disclosure;

FIG. 14 illustrates a user interface in accordance with the teachings and principles of the disclosure;

FIG. 15 illustrates a user interface in accordance with the teachings and principles of the disclosure;

FIG. 16 illustrates a user interface in accordance with the teachings and principles of the disclosure; and

FIG. 17 illustrates a block diagram of an example computing device in accordance with the teachings and principles of the disclosure.

### DETAILED DESCRIPTION

With the increased desire for water conservation while maintaining a healthy yard and crops, it has become important to use the advances in technology and communication systems to provide efficient use of water resources. Often the duration and timing for watering using an irrigation system is the only thing that is controllable because water pressure is provided through a utility or other entity that provides water. The present disclosure discusses systems, methods, and devices that regulate water use to limit over-watering while maintaining aesthetically pleasing or healthy landscapes.

In many irrigation systems, a schedule is explicitly set by a user and then is implemented by an irrigation system. However, users often overwater or water at times or at frequencies that cause water waste or even harm plants or landscapes. The present disclosure discusses various embodiments of dynamic irrigation schedules or protocols where control of an irrigation system is dynamic based on current weather conditions (such as temperature, precipitation, wind, time of day, or the like), a location (such as zip code or more accurate positioning system location, shade attributes, angle or grade of the landscape, or the like), a time of year, and/or the like. Embodiments disclosed herein may allow for healthy plant life with minimal water usage.

In some cases, further water savings or optimization may be obtained by obtaining feedback or preferences from a user (such as a land owner or care taker). For example, Applicants have recognized that some users may prefer that a lawn be as green as possible while other users are satisfied with health, but less-green lawns. Thus, water savings may be obtained by allowing users to indicate that they prefer a more dry lawn if that allows for more water savings. However, if a dynamic watering schedule that is automatically calculated or generated by a system or computer is used, a user may not have the knowledge or even the ability to determine how to modify a dynamic watering schedule or protocol to more closely match the watering preferences of the user.

Based on the foregoing, Applicants have developed systems, methods, and devices for dynamic irrigation with user adjusted control. For example, user input or user preferences regarding wetness levels may be used as an input to dynamic scheduling or protocols so that the benefits of dynamic watering and user specific preferences can be obtained. According to one example embodiment, an irrigation schedule control system includes a schedule component, a control component, a wetness feedback component, and an update component. The schedule component is configured to determine a dynamic watering schedule to replenish water in a root zone for an irrigation zone. The schedule component may determine the dynamic watering schedule by dynamically calculating a watering frequency and a watering duration to replenish water in the root zone for the irrigation zone based on one or more of weather data, a time of year, or a location corresponding to the irrigation zone. The control component is configured to control an irrigation system to water the irrigation zone based on the dynamic watering schedule. The wetness feedback component is configured to receive user input indicating a preference to increase or decrease wetness for the irrigation zone. For example, in response to irrigation of the irrigation zone according to the dynamic watering schedule, the user may decide that the irrigation zone is too wet or too dry and provide input regarding the user's preferences to make the irrigation zone more or less wet. The update component configured to, in response to the user input, modify the dynamic watering schedule based on the user input to increase or decrease wetness for the irrigation zone.

A detailed description of systems and methods consistent with embodiments of the present disclosure is provided below. While several embodiments are described, it should be understood that this disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments may be practiced without some or all of these details. Moreover, for the purpose of clarity, certain technical material that is known in the related art has not been described in detail in order to avoid unnecessarily obscuring the disclosure.

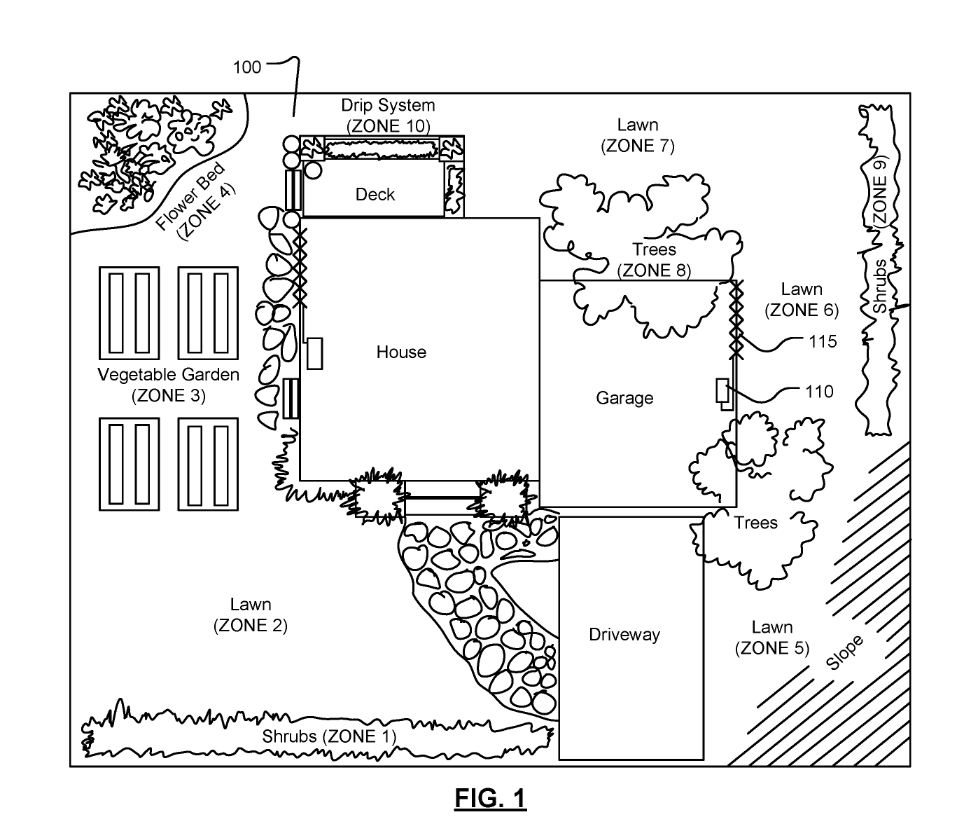

FIG. 1 illustrates an overhead view of a landscaped yard 100 surrounding a house. As can be seen in the figure, the yard has been divided into a plurality of zones. For example, the figure is illustrated as having ten zones, but it will be appreciated that any number of zones may be implemented by the disclosure. It will be appreciated that the number of zones may be determined based on a number of factors, including soil type, plant type, slope type, area to be irrigated, etc. which will help determine the duration that needed for each zone. It will be appreciated that the number of zones that may be irrigated may be determined by the controller and its zonal capacity. For example, a controller may have a capacity of eight, meaning that the controller can optimize eight zones (i.e., Zone 1-Zone 8). However, it will be appreciated that any zonal capacity may be utilized by the disclosure.

Additionally, each zone may be irrigated with differing durations as needed by the conditions and crops within the zone, as determined by a water schedule or controller. The durations may be generated using an irrigation protocol so as to compensate for differences within the irrigation plumbing if needed. For example, in an implementation the exact flow volume of the plumbing system within each zone may not be known, however the methods and systems disclosed herein will adjust the durations of irrigations sessions in accordance with query responses received from the user associated with the zones in question.

In an implementation, each zone may have different watering needs. Each zone may be associated with a certain control valve 115 that allows water into the plumbing that services each area, which corresponds to each zone. As can be seen in the figure, a zone may be a lawn area, a garden area, a tree area, a flower bed area, a shrub area, another plant type area, or any combination of the above. It will be appreciated that zones may be designated using various factors. In an implementation, zones may be designated by the amount of shade an area gets. In an implementation, zones may be defined according to soil type, amount of slope present, plant or crop type and the like. In some implementations, one or more zones may comprise drip systems, or one or more sprinkler systems, thereby providing alternative methods of delivering water to a zone.

It will be appreciated, as illustrated in FIG. 1, that a landscape may have a complex mix of zones or zone types, with each zone having separate watering needs. Many current watering systems employ a controller 110 for controlling the timing of the opening and closing of the valves within the plumbing system, such that each zone may be watered separately. These controllers 110 or control systems usually run on low voltage platforms and control solenoid type valves that are either completely open or completely closed by the actuation from a control signal. Often control systems may have a timing device to aid in the water intervals and watering times. Controllers have remained relatively simple, but as disclosed herein below in more detail, more sophisticated controllers or systems will provide optimization of the amount of water used through networked connectivity and user interaction as initiated by the system.

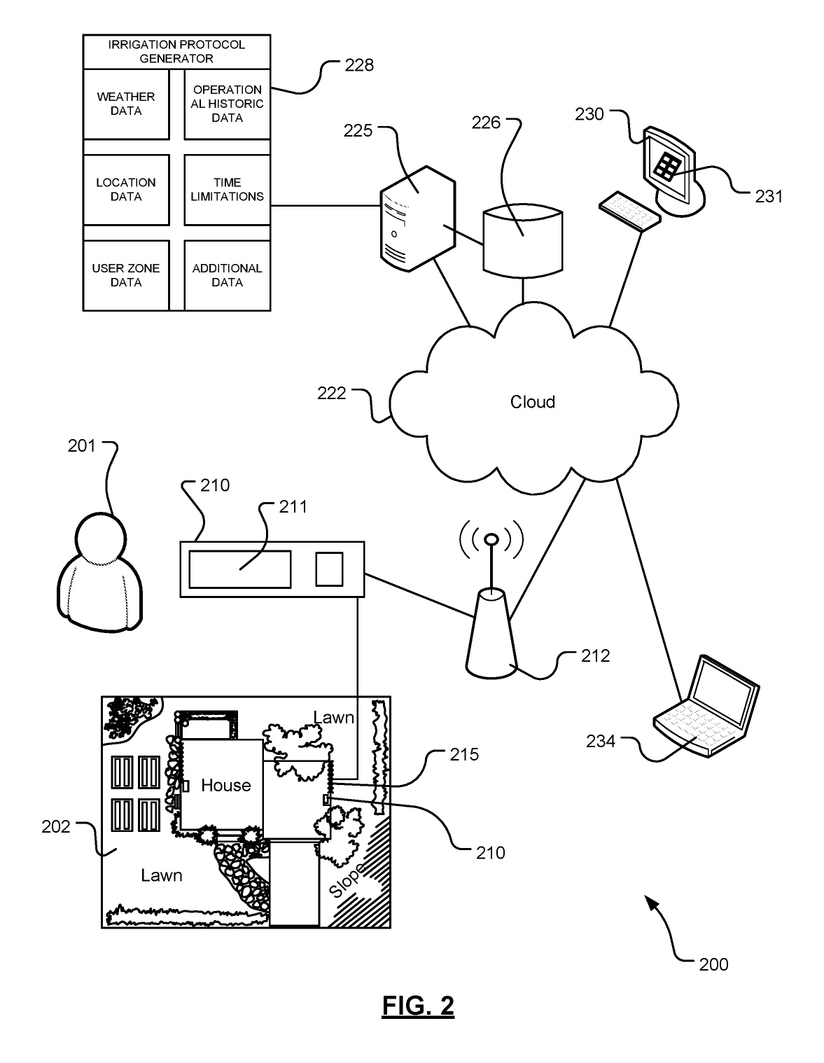

FIG. 2 illustrates a schematic diagram of an optimized irrigation control system 200 that communicates over network in order to benefit from user entered and crowd sourced irrigation related data stored and accessed from a database 226. As illustrated in the figure, a system 200 for providing automated irrigation may comprise a plumbing system, such as a sprinkler system (all elements are not shown specifically), having at least one electronically actuated control valve 215. The system 200 may also comprise a controller 210 that may be electronically connected to or in electronic communication with the control valve 215. The controller 210 may have a display or control panel and an input for providing information to and receiving information from the user. The controller 210 may comprise a display or a user interface 211 for allowing a user to enter commands that control the operation of the plumbing system. The system 200 may also comprise a network interface 212 that may be in electronic communication with the controller 210. The network interface 212 may provide network 222 access to the controller 210. The system 200 may further comprise an irrigation protocol server 225 providing a web based user interface 231 on a display or computer 230. The system 200 may comprise a database 226 that may comprise data such as weather data, location data, user data, operational historical data, and other data that may be used in optimizing an irrigation protocol from an irrigation protocol generator 228.

The system 200 may further comprise a rule/protocol generator 228 using data from a plurality of databases for generating an irrigation protocol, wherein the generation of an irrigation protocol is initiated in part in response to at least an input by a user. It should be noted that the network 222 mentioned above could be a cloud computing network, and/or the internet, and/or part of a closed/private network without departing from the scope of the disclosure.

Additionally, as illustrated in FIG. 2, access may be granted to third party service providers through worker terminals 234 that may connect to the system through the network 222. The service providers may be granted pro-status on the system and may be shown more options through a user interface than a home owner because of their knowledge and experience, for example, in landscaping, plumbing, and/or other experience. In an implementation, worker terminals may be a portable computing device such as portable computer, tablet, smart phone, PDA, and/or the like.

An additional feature of the system 200 may be to provide notices or notifications to users of changes that impact their irrigation protocol. For example, an implementation may provide notice to a home owner/user that its professional lawn service has made changes through a worker terminal 234. An implementation may provide a user the ability to ratify changes made by others or to reject any changes.

In an implementation, an irrigation system 200 may comprise a plurality of control valves 215, wherein each control valve corresponds to a zone of irrigation. As will be discussed in detail below, one of the advantages of the disclosed optimization system is that the flow consistency of the plumbing and control valve may be compensated for by adjusting the durations of irrigation sessions in accordance to user feedback obtained through a plurality of queries as discussed in greater detail below.

In an implementation, user communication may be facilitated through a mobile application on a mobile device configured for communicating with the irrigation protocol server 225. One or more notifications may be provided as push notifications to provide real time responsiveness from the users to the system 200.

The system 200 may further comprise an interval timer for controlling the timing of when the notifications are sent to users or customers, such that users/customers are contacted at useful intervals. For example, the system 200 may initiate contact with a user after predetermined interval of time has passed for the modifications to the irrigation protocol to take effect in the landscape, for example in plants, shrubs, grass, trees and other landscape. In an implementation, the notifications may ask the user to provide information or indicia regarding such things as: soil type of a zone, crop type of a zone, irrigation start time, time intervals during which irrigation is occurring, the condition of each zone (e.g., how wet or dry the soil in the zone is, how green or healthy plants in the zone appear), or other types of information or objective indicia.

Optimization of the irrigation and plumbing system may be to provide the requisite water needed to maintain a healthy landscape and no more. Thus, the general understanding is that the amount of water that is lost during evapotranspiration per zone must be replenished at each irrigation start and run time. Evapotranspiration is the amount of water lost from the sum of transpiration and evaporation. The U.S. Geological Survey defines evapotranspiration as water lost to the atmosphere from the ground surface, evaporation from the capillary fringe of the groundwater table, and the transpiration of groundwater by plants whose roots tap the capillary fringe of the groundwater table. Evapotranspiration may be defined as loss of water from the soil both by evaporation from the soil surface and by transpiration from the leaves of the plants growing on it. It will be appreciated and understood that factors that affect the rate of evapotranspiration include the amount of solar radiation, atmospheric vapor pressure, temperature, wind, and soil moisture. Evapotranspiration accounts for most of the water lost from the soil during the growth of a plant or crop. Accurately estimating evapotranspiration rates is an advantageous factor in not only planning irrigation schemes, but also in formulating irrigation protocols to be executed by a controller to efficiently use water resources.

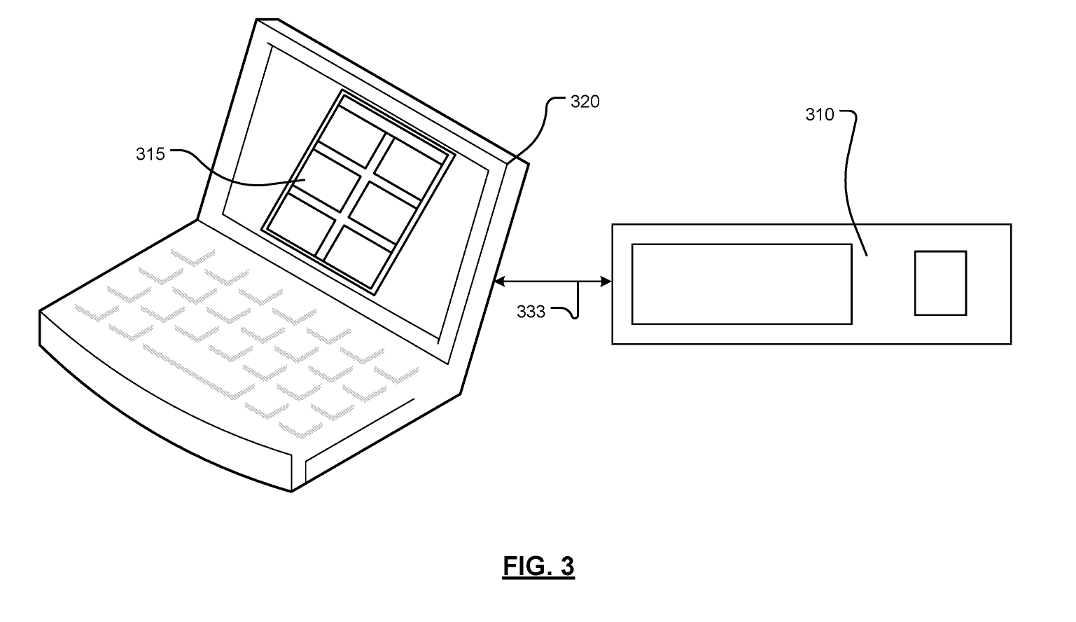

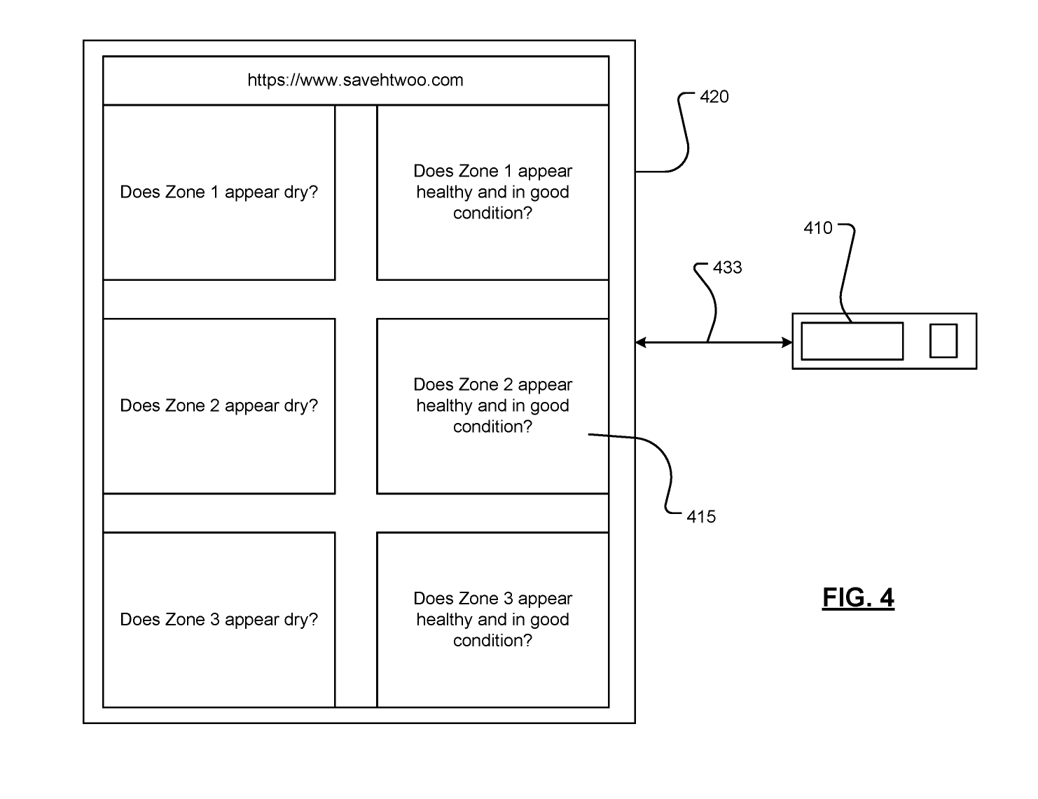

Illustrated in FIGS. 3 and 4 are schematic diagrams of a pairing between a user's control unit and an account, such as a web account. In an implementation illustrated in FIG. 3, the system may perform a pairing operation 333 between the controller 310 and a web based service in order to initiate the system 200 of FIG. 2. A user may electronically connect (pair) a controller 310 to an associated web account 315 viewed on a computer 320 in order to ease the collection of user data. It will be appreciated that a user would not be required to enter the desired user data through the limited input capabilities of a feasible irrigation controller 310, although it may be possible for a user to enter information via the controller 310. Rather, a user/customer could conveniently enter data from a computer 320 having a web interface 315 representing a user account. A pairing operation 333 may be used to connect the web account 315 and the controller 310. Once the pairing is complete the data entered into the user account may be used to generate irrigation protocols for the controller 310 to execute. It will be appreciated that pairing process or operation 333 may involve user interaction. This user interaction may be the basis for confirming the identity of the controller 310 and the web account 315. Once pairing successfully completes, a bond or link will have been formed between the controller 310 and the web account 315, enabling the controller 310 and the web account 315 to connect to each other in the future without requiring the pairing process in order to confirm the identity of the devices.

Referring now to FIG. 4, pairing between a user's control unit and an account, such as a web account is illustrated. A user may electronically connect (pair) a controller 410 to an associated web account viewed on a computer 420 in order to ease the collection of user data. A user/customer may conveniently enter data from a computer 420 having a web interface 415 representing a user account. A pairing operation 433 may be used to connect the web account and the controller 410. Once the pairing is complete the data entered into the user account may be used to generate irrigation protocols for the controller 410 to execute.

In an implementation, the pairing process 333 or 433 may involve establishing a relationship between the controller 310, 410 and the account. During the pairing process, the device(s) and the account involved establish a relationship by creating a shared secret code or a link key. If the code or link key is stored by both the device and the account they are said to be paired or bonded. A device that wants to communicate only with a bonded device can cryptographically authenticate the identity of the other device or account, and so be sure that it is the same device or account it previously paired with. Once a link key has been generated, an authenticated Asynchronous Connection-Less (ACL) link between the devices may be encrypted so that the data that they exchange over the airwaves is protected against eavesdropping.

It will be appreciated that the disclosure may utilize any pairing process or mechanism that are known or that may become known without departing from the scope of the disclosure. Pairing mechanisms may include legacy pairing, secure simple pairing (SSP), or other pairing mechanisms.

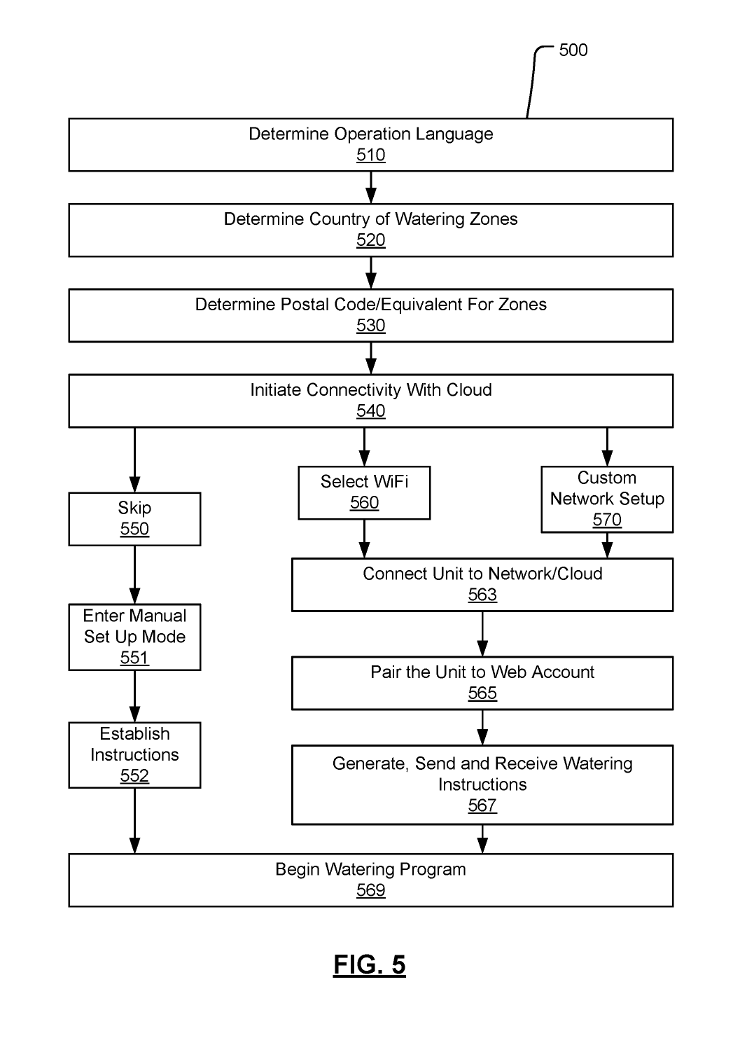

FIG. 5 illustrates a method 500 for initiation of an irrigation optimization system having the features of the disclosure. The method 500, may initiate at 510 by determining the language the user will use in interacting with the system. The user selection will be recorded into computer memory on the system. At 520, the geo graphical location of the user may then be determined, and at 530 the geographical location of the zones may be further refined using more specific questions about the geographical location, such as querying about a postal code or equivalent thereof in different areas of the world. Once the location has been established, the system 500 may then establish connectivity with a cloud network at 540.

At 550, the network connectivity may be skipped and at 551 a user may be asked to manually set up a watering protocol by responding to questions from the controller. At 552, a watering protocol of instructions will be generated and stored for the controllers use and at 569 the controller is ready for use and irrigation may begin automatically based on the protocol of instructions provided to the controller.

Alternatively, at 560 a user may be presented with available Wi-Fi connection options and may choose the desired connection, or at 570 a user may enter custom network settings directly. At 563, the controller or unit may be connected to the network or cloud.

Once connected to the network or cloud, at 565 the controller may be paired with an online account previously (or concurrently) set up through a web interface or other interface as seen in FIGS. 3 and 4.

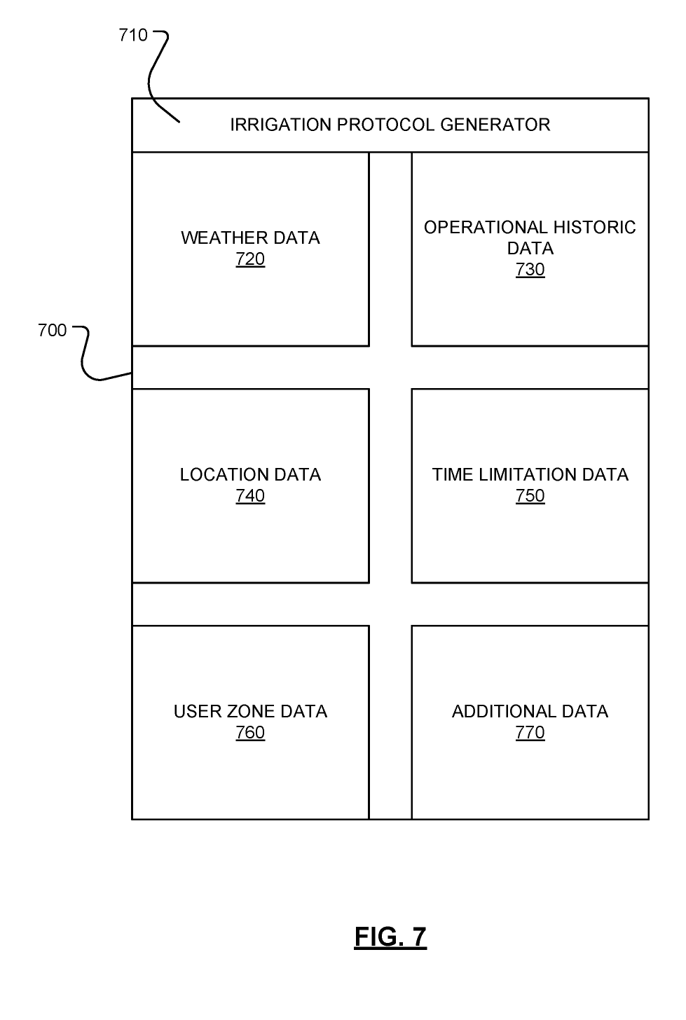

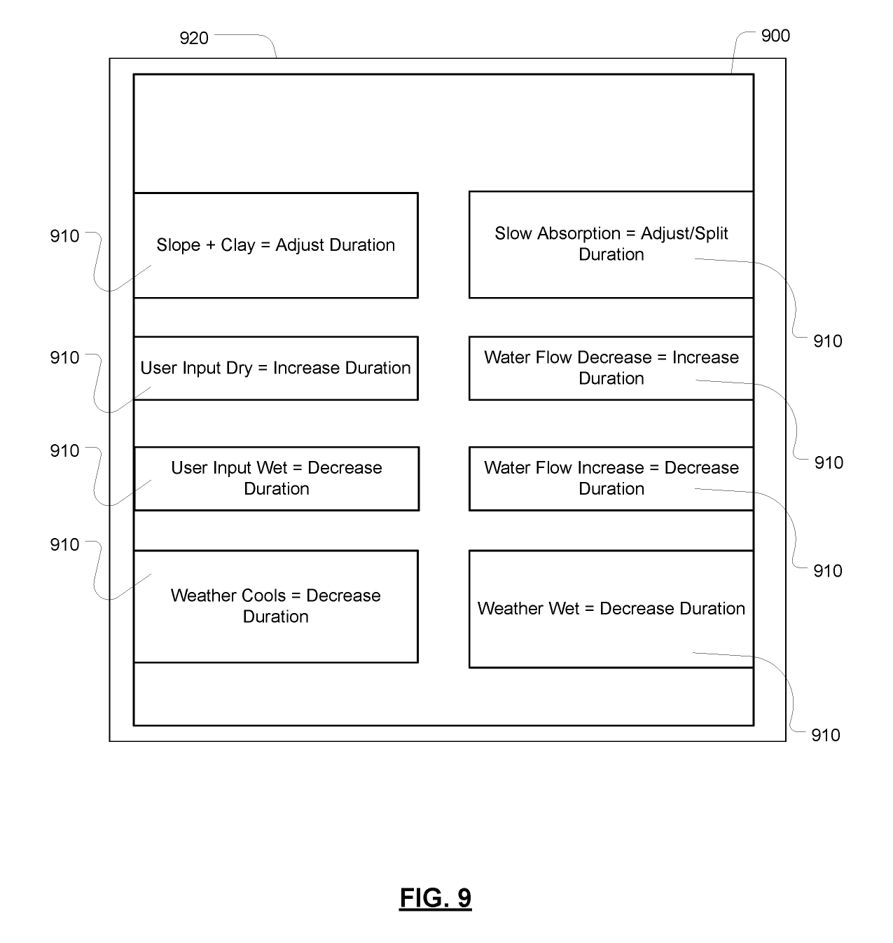

At 567, a watering protocol may be generated by an irrigation protocol generator (illustrated best in FIGS. 7 and 9). The protocol may be sent and transmitted through the network or cloud to the paired controller. The watering instructions or protocol may be formulated and generated, at least in part, based on user responses to queries output from the system through the web account or through the control panel user interface of the controller.

At 569, the controller is ready for use and irrigation may begin automatically based on the protocol of instructions provided to and received by the controller from the network or cloud.

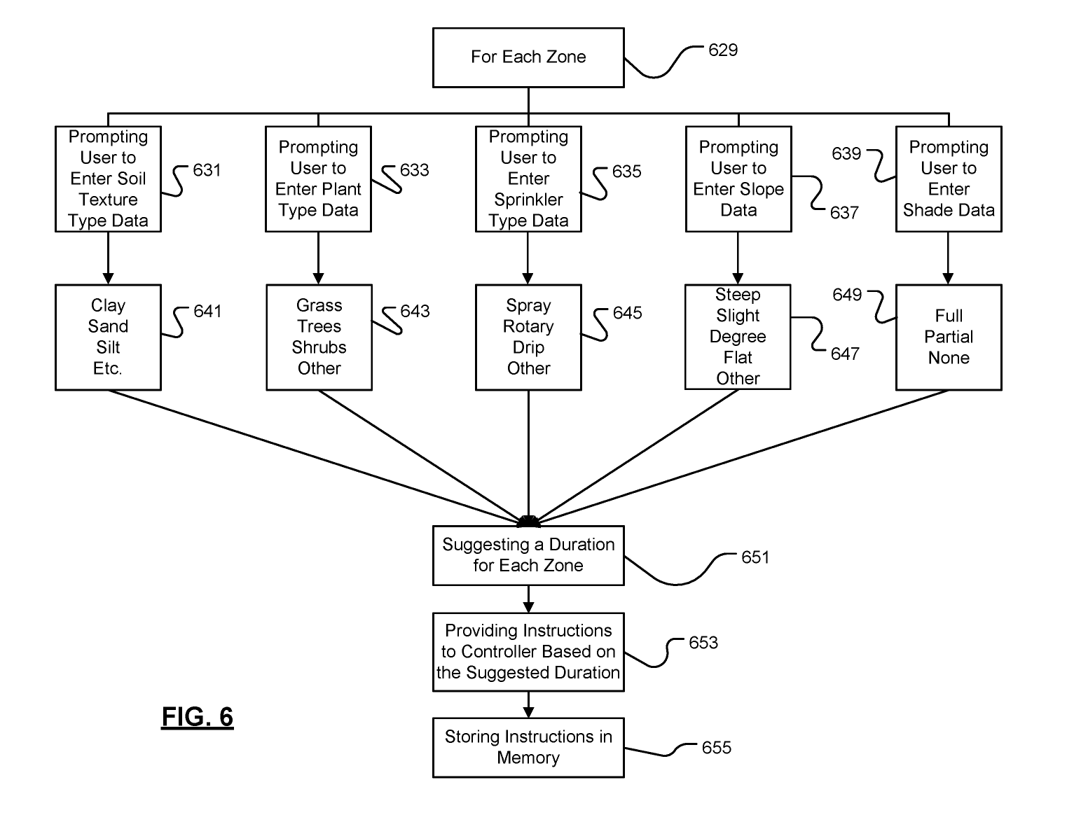

Referring now to FIG. 6, there is illustrated a method for setting up each zone of a smart irrigation system. At 629, the system may set up each zone individually. The system may prompt the user to input or select various parameters or criteria for each zone. At 631, the system may prompt the user to input or select data relating to the soil texture type. For example, the system may ask the user to input or select clay, sand, silt, or other soil texture type at 641. At 633, the system may prompt the user to input or select data relating to the plant type. For example, at 643, the system may ask the user to input or select grass, trees, shrubs, flowers, or other plant type data in order to determine the amount of water that may be lost through evapotranspiration. At 635, the system may prompt the user to input or select data relating to the sprinkler or plumbing fixture type. For example, the system may ask the user to input or select a spray sprinkler, a rotary sprinkler, a drip system, or other sprinkler or plumbing fixture type at 645. At 637, the system may prompt the user to input or select data relating to the slope type. For example, the system may ask the user to input or select steep slope, slight slope, flat slope, or a certain degree of slope at 647. At 639, the system may prompt the user to input or select data relating to the shade type. For example, the system may ask the user to input or select full shade, partial shade, no shade, or other shade data at 649. At 651, the system may receive and store the inputs and selections from the user. The system may utilize the inputs and selections from the user and run the information through a duration protocol generator to generate and suggest a protocol for watering each zone for a specified duration. At 653, the protocol or instructions may be sent to the controller. At 655, the protocol or instructions may be stored in memory in the controller for automatically initiating the irrigation system.

FIG. 7 illustrates a schematic diagram of a database 700 and protocol generator 710 in accordance with the features of the disclosure. For example, as can be seen in the figure, a database 700 may comprise weather data 720, operational historic data 730, location data 740, time limitation data 750, user zone data 760, and other data 770, such as crop or plant type data. The time and date may also be generated by a time generator and/or supplied by a database. The network or cloud may supply such data to a server or database to generate operating instructions, which in turn may be sent to the controller. In various implementations, one or more databases may be spread over a plurality of computers and computing devices that are in communication over the network. In an implementation, some data may be supplied by third party providers and may be aggregated from many sources. In an implementation, some data may be entered by users such as customers and service personnel.

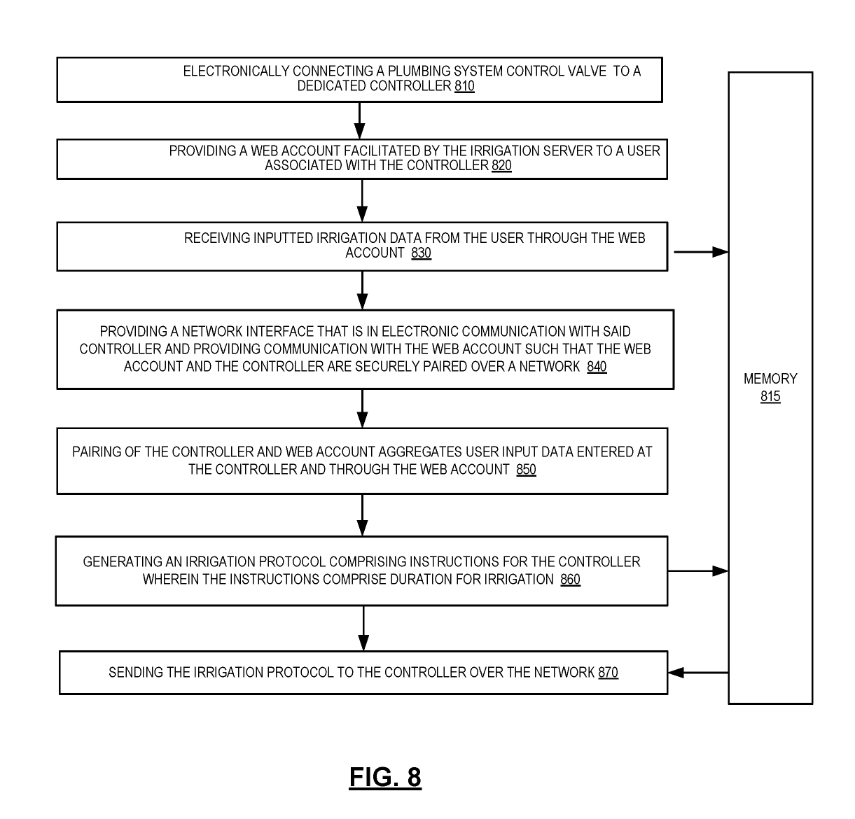

FIG. 8 is a graphical representation of a method for providing duration optimized watering protocols. As discussed previously, in an irrigation system it may not be possible to know the precise flow of the irrigation fluid within the system. Further the flow and pressure within the system may change over time or a user's preferences may change. Accordingly, to optimize an irrigation system it may be necessary to adjust the duration of irrigation systems in order to achieve the desired results of the user.

An implementation of a method for providing optimized and automated irrigation may comprise the process of electronically connecting a plumbing system having an electronically actuated control valve for controlling the flow of water through the plumbing system to a dedicated controller electronically and directly connected to said control valve and configured for sending actuation signals to the control valve thereby controlling water flow through the plumbing system at 810. For example, a controller may be wired to a plurality of control valves such that electronic signals may be sent from the controller to the control valves within an irrigation system. Once electronic communication has been established between the controller and the control valves the duration of irrigation sessions may be controlled by the controller. In an embodiment, computer readable irrigation instructions may be provided to the controller from an irrigation server comprising at least a computer processor and memory. In an implementation preliminary instructions may be provided to the controller, or previously optimized instructions may be provided to the controller over a network.

At 820, a web account facilitated by the irrigation server may be provided to a user wherein the web account may be associated with the controller. In an implementation, a web account may be provided thereby allowing data entry by the user regarding the health of the crops within various zones.

At 830, data such as responses to queries may be received into the system and stored in memory. As discussed above, a user may be responding to crop health queries, or dryness/wetness levels in a zone, previously sent from the system. These responses may then be stored in memory at 815 to be used in generating an irrigation protocol that has been generated with regard to the user data inputs.

At 840, a network interface may provide connectivity between the user account on the irrigation server and the controller. At 850, the user account and the controller have been paired such that the irrigation server may provide relevant protocols that correspond to user inputs to the controller. In an implementation, after the pairing a user may be prompted for additional information such that the system may receive updated inputted irrigation data from the user through the web account.

At 860, an irrigation protocol comprising instructions for the controller may be generated/derived from at least in part from the user data entered. As discussed above the primary form of the instructions is to control the duration of irrigation at a constant flow through the plumbing system. It should be noted that duration may be spread over a plurality of irrigation sessions. In some implementations the durations maybe determined for a 24-hour period, weekly period, monthly period, or other periods such that the irrigation system will irrigate for a total duration whether all in one session or split among a plurality of sessions.

In an implementation, the durations that are generated may be determined according to a multi-day period such that the irrigation system will irrigate for a total duration whether all in one session or split among a plurality of sessions. For example, the system may take into account restrictions imposed by municipalities, such that watering is not allowed during certain parts of the day or certain days of the week. Accordingly, the total duration may be split in order to work around the restrictive times and dates. For another example, the slope of an area may not allow the saturation needed for the soil conditions and slope. Clay, for example, has a slow absorption rate and clay if on a slope will produce more runoff than absorption. Accordingly, the protocol generator of the system may instruct the controller to water fractions of the duration in many irrigation sessions. The sessions having split durations may be equal or may be unequal in duration. At 870, an irrigation protocol may be sent to the controller over the network.

Illustrated in FIG. 9 is a schematic representation of a protocol generator in accordance with the disclosure. As can be seen in the figure, the generator 900 may comprise a plurality of algorithms 910 that operate on the data received into the system to produce optimized watering protocols. The protocol generator may reside within the irrigation server 920 or may be located in a watering controller on site of an irrigation system.

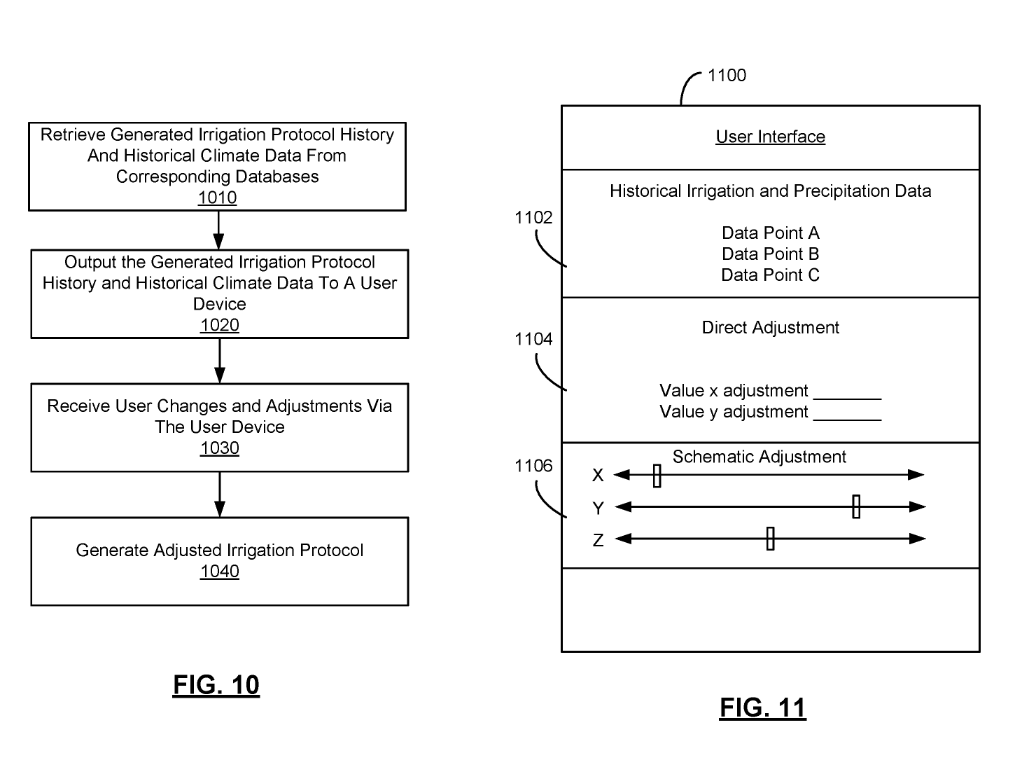

FIG. 10 illustrates one embodiment of a method for receiving and incorporating user adjustments into a previously generated irrigation protocol. A user may be presented with precipitation data based on such things as historical averages for the area, personal knowledge and experience regarding how the subject ground absorbs and retains precipitation, and/or irrigation protocol history. The method may output precipitation data based on a reference day in order to provide the user with insight into desired or actual watering frequency. At 1010, a system retrieves generated irrigation protocol history and historical climate data. At 1020, the system outputs the generated irrigation protocol history and the historical climate data for viewing by a user. The information may provide insight into the frequency of watering based on historical averages in order to efficiently use the water. At 1030, the system may receive user adjustments from the user via a controller. The controller may allow the user to adjust and/or directly change the underlying values within a generated irrigation protocol that will help obtain a desired result. At 1040, the system generates an adjusted irrigation protocol incorporating the user's adjustments and changes.

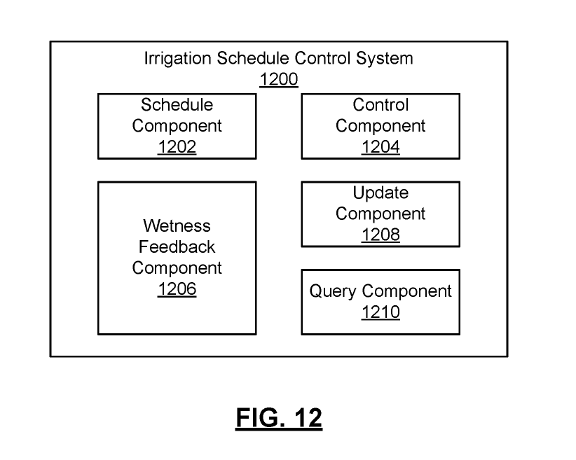

FIG. 11 illustrates one embodiment of an interface 1100 for presenting historical irrigation and precipitation data to a user and receiving user adjustments. The interface 1100 includes a reference point section 1102 where data points for water frequency, duration, precipitation data, or other historical irrigation or precipitation data can be displayed for a user. The data points may allow a user to understand that the frequency of watering is based on weather and how much water a zone has received in the past. For example, an embodiment may generate averages for 14 days prior to the actual reference date and 14 days after the actual reference date may be calculated and displayed. As another example, irrigation frequency may be calculated based on a water capacity for a zone divided by a depletion amount associated for plant type or zone. For example, the water capacity is the amount of water that can be held by the corresponding root zone.

The user interface 1100 also includes a direct adjustment section 1104 where a user can enter a specific value to adjust a watering duration or watering frequency for a zone. For example, the x value in the direct adjustment section 1104 may represent an adjustment for water capacity for a zone while the y value in the direct adjustment section 1104 may represent a depletion rate for the zone. Based on the adjustments, a watering schedule, watering frequency, watering duration, or the like may be recalculated. The user interface 1100 also includes a schematic adjustment section 1106 where a user can generally indicate an increase or decrease in one or more values for watering. For example, the schematic adjustment section 1106 provides graphical sliders that the user can move to indicate values for different adjustments. For example, a user may slide a slider to the left to indicate a reduced watering amount or frequency and slide the slider to the right to indicate an increased watering amount or frequency. A slider placed in the middle may indicate no adjustment.

In one embodiment, by using the reference data (and hence water loss), the user has the ability to manually and directly change the frequency and/or duration of the irrigation. The changes may be changed drastically or minimally using an intuitive, easy user interface as illustrated in FIG. 14. For example, an adjustment may comprise simply changing the delta from the point the system recommends, so that the user now has the ability to feel in control of the system. In an implementation having an advance mode, and expert user may change the water capacity value and or change the plant coefficient values in order to make the desired adjustments. If they do change frequency or underlying values then the system may the recalculate all of the related values based on the user change.

Example values, which may be directly or schematically adjusted by a user, include water capacity for a zone, depletion rate for a zone, and/or sprinkler rate. The water capacity for the zone may indicate the total volume of water that a root zone in an irrigation zone can hold. The depletion rate may indicate how quickly water in the zone is depleted (either from flowing away through the soil, evaporation, and/or transpiration by plants. The sprinkler rate may indicate a flow rate for the sprinklers in the zone. The sprinkler rate may be used to determine how long the sprinklers need to run in order to fill a root zone to a desired capacity.

The interface 1100 may allow a user to change a frequency and duration for watering in the system. Presenting data points allows a user to gain insight into the frequency of watering based on historical averages in order to efficiently use the water. The interface 1100 allows a user to adjust and have a more direct change of the underlying values that will help them obtain a desired result.

In one embodiment, the interface 1100 may be accessed by a user while a system performs a method for adjusting the frequency/duration of watering based on a user's assumptions and knowledge of their specific landscape. The method may include computing dated reference points to that the user can understand that the frequency of watering is based on weather. One embodiment averages water loss for 14 days prior to and 14 days after a current or reference data and presents this to a user as a data point.

In one embodiment, the system calculates watering frequency based on a water capacity for a root zone (amount of water that can be held by the root zone) divided by an amount of depletion for a plant type. The depletion may be calculated by taking a total water loss multiplied by a plant coefficient. By using a reference date (and hence reference water loss), the user has the ability to manually and directly change the frequency or minutes or some combination of both. The changes may be changed drastically or a very minor change using an intuitive, easy user interface (changing the delta from the point the system recommends) so that the user now has the ability to feel in control of the system. Providing a user with a feeling of control in a dynamic watering protocol can be important. In advanced settings, a user (such as an expert) can change the water capacity, change the plant coefficient, or other specific values that affect how a water schedule (timing, frequency, and/or duration for watering) is calculated.

If a user does make a change to a value, such as watering frequency or an underlying value, the system recalculates all of the related values based on the user change. Thus, the user may provide input while still allowing the system to provide dynamic watering schedules and protocols. This allows the system to leverage user expertise or preferences while still enabling dynamic watering that irrigates only as needed.

In one embodiment, the system may compute values that relate to determining an irrigation system rate (such as a sprinkler rate or precipitation rate). For example, the system may determine how long and/or how frequently a region should be watered to maintain the presence of water within a root zone of an irrigation zone. For example, a needed precipitation rate may be calculated by dividing the water capacity for a root zone by the amount of depletion for the plant type in that zone. The resulting value may be presented in the required precipitation rate per time period (hour, day, week, month, or other time period). In one embodiment, to calculate water capacity based on a change in the frequency, a plant coefficient or evapotranspiration (ET, or water loss) the system may calculate a compounded ET (evapotranspiration multiplied by a plant coefficient) and multiply the compounded ET by a desired frequency. The system may also sum the result of the previous calculation with a compounded ET or constant to help resolve rounding errors.

FIG. 12 is a block diagram illustrating example components of an irrigation schedule control system 1200, according to one implementation. In the depicted embodiment, the irrigation schedule control system 1200 includes a schedule component 1202, a control component 1204, a wetness feedback component 1206, an update component 1208, and a query component 1210. The components 1202-1210 are given by way of illustration only and may not all be included in all embodiments. In fact, some embodiments may include only one or any combination of two or more of the components 1202-1210. The irrigation schedule component may be located on a server or a controller, for example as part of the irrigation protocol server 225 or the controller of FIG. 2.

The schedule component 1202 is configured to determine a dynamic watering schedule to replenish water in a root zone for an irrigation zone. For example, the schedule component 1202 may perform any of the calculations or scheduling as discussed in relation to irrigation protocol generator 228 or any of the previous figures. In one embodiment, the schedule component 1202 determines a dynamic watering schedule by dynamically calculating a watering frequency and a watering duration to replenish water in the root zone for the irrigation zone based on one or more of weather data, a time of year, or a location corresponding to the irrigation zone. The schedule component 1202 may determine one or more parameters for an irrigation zone and then, based on those parameters, generate a watering schedule. For example, the schedule component 1202 may determine a water capacity for a root zone, a water loss rate for the root zone, and/or a precipitation rate for a sprinkler system. Based on these values, the schedule component 1202 may determine scheduling to keep at least a minimum amount of water within the root zone for the irrigation zone.

In one embodiment, the schedule component 1202 is configured to determine a dynamic watering schedule that causes the irrigation system to vary, over time, one or more of the watering frequency or the watering duration for the irrigation zone. In one embodiment, the schedule component 1202 determines the dynamic watering schedule by periodically recalculating water timing, duration, and/or frequency. For example, the schedule component 1202 is configured to dynamically calculate the watering frequency and the watering duration by periodically calculating the watering frequency and the watering duration based on current or updated values for the weather data, the time of year, or user input regarding plant health status or a wetness status of an irrigation zone. The schedule component 1202 may also recalculate or re-determine the watering schedule in response to receiving updated information. For example, the update component 1208 may provide updated user input, weather input, or other data and the schedule component 1202 may recalculate a schedule or underlying values for a watering protocol.

The control component 1204 is configured to control an irrigation system to water the irrigation zone based on the dynamic watering schedule. For example, the control component 1204 may generate and/or provide instructions or a portion of the dynamic watering schedule to an irrigation controller of the irrigation system to water the irrigation zone. For example, if the irrigation schedule control system 1200 is located on a server, the control component 1204 may send scheduling information or watering instructions to a controller that actuates or triggers watering of irrigation zones.

The wetness feedback component 1206 is configured to receive input from users regarding preferences for how wet or healthy an irrigation zone is or should be. For example, the wetness feedback component 1206 may, after an irrigation zone has been watered for a period of time, indicate to a user that the region is too wet or too dry. This input may indicate a preference for a user to increase or decrease wetness for the irrigation zone. In one embodiment, the user input may indicate an offset value over a dynamic watering schedule that the schedule component 1202 will generate without input regarding user preferences or irrigation zone wetness or dryness. In one embodiment, the wetness feedback component 1206 may receive the user input in the form of responses to queries (e.g., see FIG. 4), as general preferences that the region be more wet or more dry, or as direct numerical input for parameters of a dynamic watering schedule or protocol.

The update component 1208 is configured to, in response to user input, modify a dynamic watering schedule based on the user input to increase or decrease wetness for the irrigation zone. For example, the update component 1208 may receive the user input received by the wetness feedback component 1206. In one embodiment, the update component 1208 is configured to modify the dynamic watering schedule by recalculating the watering frequency or the watering duration to replenish water in the root zone for an irrigation zone. The amount of water, the duration, and/or the frequency for watering as updated by the update component 1208 may be based on the preference of a user and weather data, a time of year, a location, a soil type, and/or any other information about the irrigation zone. In one embodiment, the update component 1208 is configured to modify the dynamic watering schedule by increasing a frequency of watering without increasing a total watering duration within a time period. In one embodiment, the update component 1208 is configured to modify the dynamic watering schedule by increasing a total watering duration for the irrigation zone over a time period.

The query component 1210 is configured to provide a query to a user. For example, the query component 1210 may provide a query to the user requesting input regarding a status of the soil or plants in the irrigation zone, wherein the status indicates a wetness or health of the soil or plants. The query component 1210 may periodically prompt a user for input regarding how plants are doing in an irrigation zone. The query component 1210 may provide a query with questions or prompt input as illustrated in FIG. 4 and FIG. 9.

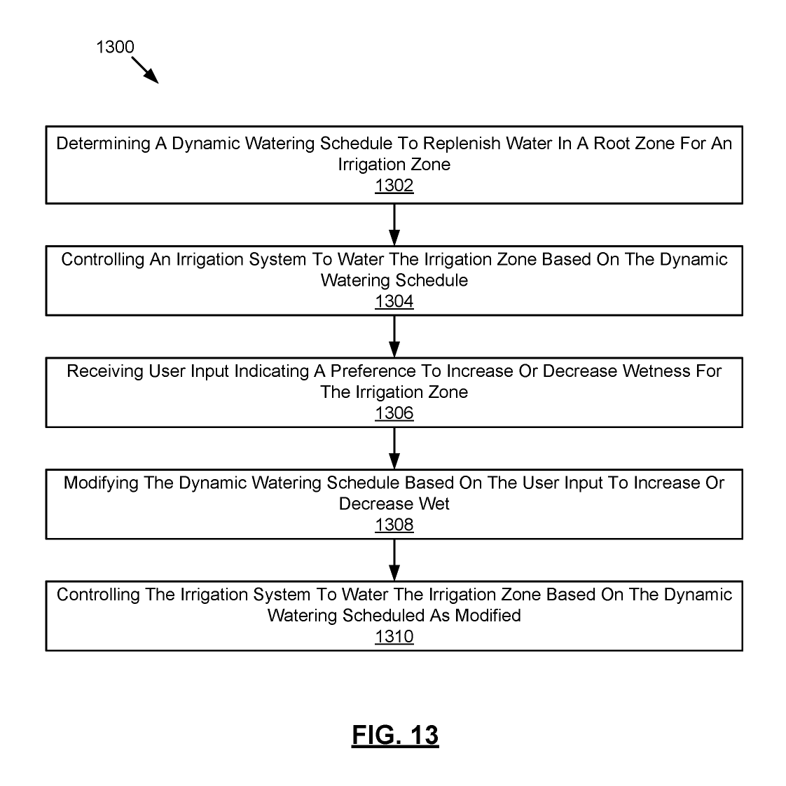

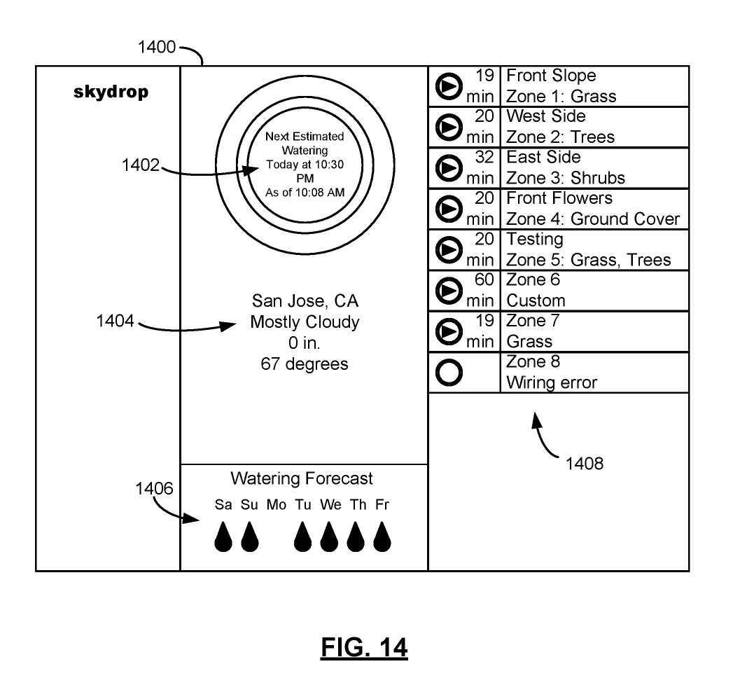

Referring now to FIG. 13, a schematic flow chart diagram of a method 1300 for determining a dynamic watering schedule is illustrated. The method 1300 may be performed by an irrigation schedule control system 1200, such as an irrigation schedule control system within a controller or irrigation protocol server.

The method 1300 begins and a schedule component 1202 determines 1302 a dynamic watering schedule to replenish water in a root zone for an irrigation zone. The dynamic watering schedule may be determined by dynamically calculating a watering frequency and a watering duration to replenish water in the root zone for the irrigation zone based on one or more of weather data, a time of year, or a location corresponding to the irrigation zone. A control component 1204 controls 1304 an irrigation system to water the irrigation zone based on the dynamic watering schedule. The control component 1204 may control 1304 the irrigation system by sending signals to the irrigation system or a controller of the irrigation system. A wetness feedback component 1206 receives 1306 user input indicating a preference to increase or decrease wetness for the irrigation zone. An update component 1208 modifies 1308 the dynamic watering schedule based on the user input to increase or decrease wet. The control component 1204 controls 1310 the irrigation system to water the irrigation zone based on the dynamic watering scheduled as modified.

Turning now to FIGS. 14-16, example user interfaces are shown. These interfaces may be displayed on a controller, within a web browser of a user computing device, or the like. For example, a user may be able to access their account via an irrigation protocol server to provide input and/or see a watering status for their system.

FIG. 14 illustrates a status interface 1400 that shows status information for an irrigation and watering schedule. Specifically, the status interface 1400 shows the next estimated watering 1402, current weather 1404, and a watering forecast section 1406 for the next week. The status interface also shows a zone status section 1408 that displays the status of each irrigation zone. In one embodiment, a user may select one of the irrigation zones from the zone status section 1408 in order to modify settings for the zone or provide watering feedback.

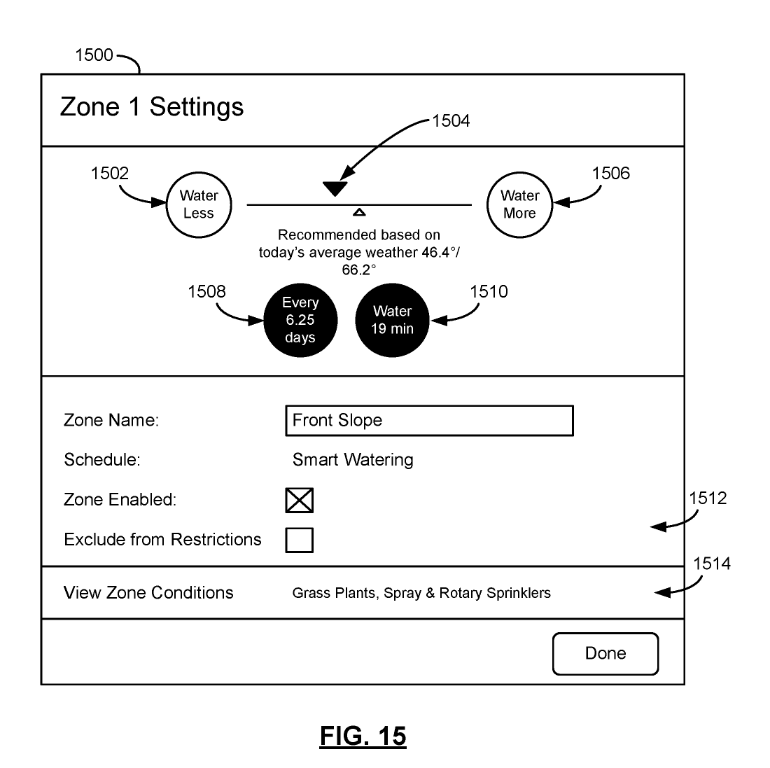

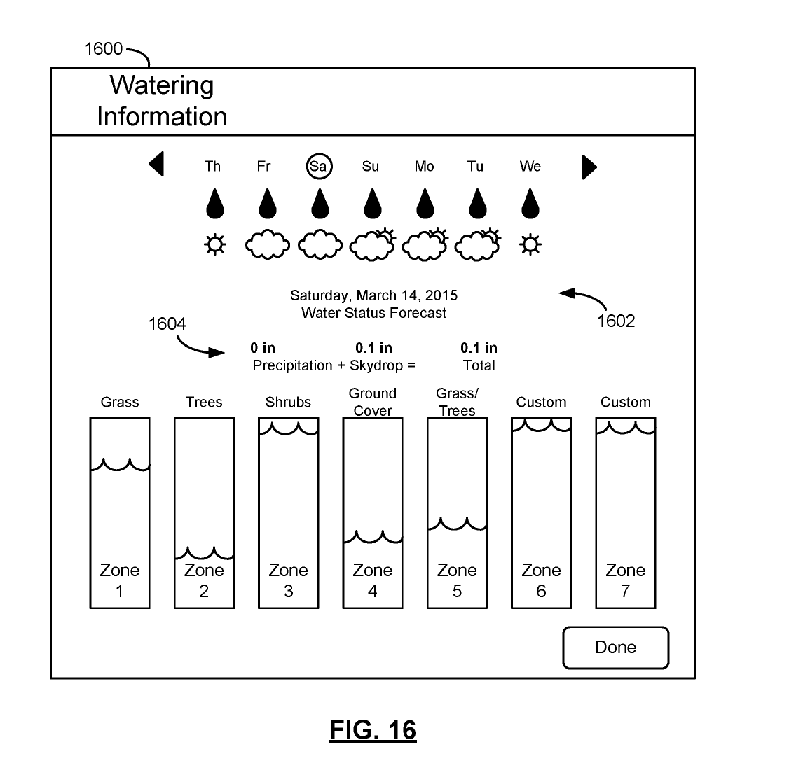

FIG. 15 illustrates a settings interface 1500, which may be displayed after selection of an irrigation zone (e.g., as displayed in FIG. 1400). The settings interface 1500 shows settings for a Zone 1 irrigation zone. The settings interface 1500 displays a less water button 1502 and a more water button 1506 to allow a user to move an indicator 1504 to increase or decrease an amount of watering over a recommended amount. Based on the position of the indicator (and/or a corresponding adjustment of the input parameters) the duration, frequency, or the like may be modified. The user may also select a frequency button 1508 to explicitly determine how often the system should water the zone given the current weather. The user may select a duration button 1510 to explicitly indicate a duration to be used when watering the zone. For example, the system may perform a method that includes: displaying information about a current weather (or average current weather); receiving input from a user indicating an explicit frequency or duration for watering a specific zone; determining an offset or adjustment (a value used to multiple, add, or otherwise modify a parameter) for a dynamic watering protocol; and dynamically generating watering schedules, durations, and frequencies for other conditions (weather, time of year, etc.) based on the offset.

The settings interface 1500 includes a zone information section 1512 that allows a user to specify a zone name, how watering is scheduled for the zone, whether the zone is currently enabled, and/or whether the zone is subject to watering restrictions. The “Smart Watering” schedule indicates that an automatic dynamic schedule is used by the system. The settings interface also includes a zone conditions section 1514 that indicates one or more conditions or details about the zone. Example zone conditions include plant type, sprinkler system type, slope, soil type, shade amount, or the like.

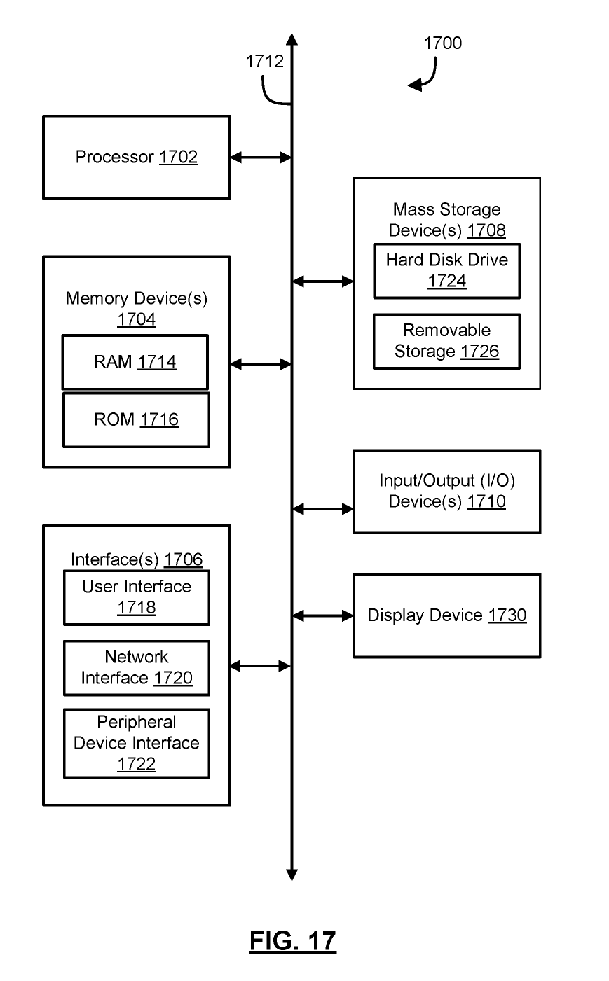

FIG. 16 illustrates a watering forecast interface 1600 for displaying a watering forecast for an irrigation system. For example, the watering forecast interface 1600 may be displayed in response to a selection of the watering forecast section 1406 in FIG. 14. The watering forecast interface 1600 includes a weather forecast section 1602 that forecasts the weather for the current location. The watering forecast interface 1600 also includes a total precipitation section 1604 that illustrates the predicted total precipitation for a landscape. For example, the watering forecast interface 1600 predicts that there will be 0 inches (0 in) of rain/snow and 0.1 inches from the irrigation system for a total of 0.1 inches over the seven day period. The watering forecast interface 1600 also illustrates a predicted amount of water in a root zone for each irrigation zone covered by an irrigation system. For example, Zone 1, which includes grass, has a relatively large amount of water in a root zone and thus may not need water, or very much water for a period of time. Zone 2, which includes trees, is low on water, but may be sufficient for trees since they have deeper root systems. The system may track a predicted, or actual, amount of water in a root zone for each zone and thereby determine if/when to water.

Referring now to FIG. 17, a block diagram of an example computing device 1700 is illustrated. Computing device 1700 may be used to perform various procedures, such as those discussed herein. Computing device 1700 can function as a server, a client, or any other computing entity. Computing device 1700 can perform various monitoring functions as discussed herein, and can execute one or more application programs, such as the application programs described herein. Computing device 1700 can be any of a wide variety of computing devices, such as a desktop computer, a notebook computer, a server computer, a handheld computer, tablet computer and the like.

Computing device 1700 includes one or more processor(s) 1702, one or more memory device(s) 1704, one or more interface(s) 1706, one or more mass storage device(s) 1708, one or more Input/Output (I/O) device(s) 1710, and a display device 1730 all of which are coupled to a bus 1712. Processor(s) 1702 include one or more processors or controllers that execute instructions stored in memory device(s) 1704 and/or mass storage device(s) 1708. Processor(s) 1702 may also include various types of computer-readable media, such as cache memory.

Memory device(s) 1704 include various computer-readable media, such as volatile memory (e.g., random access memory (RAM) 1714) and/or nonvolatile memory (e.g., read-only memory (ROM) 1716). Memory device(s) 1704 may also include rewritable ROM, such as Flash memory.

Mass storage device(s) 1708 include various computer readable media, such as magnetic tapes, magnetic disks, optical disks, solid-state memory (e.g., Flash memory), and so forth. As shown in FIG. 17, a particular mass storage device is a hard disk drive 1724. Various drives may also be included in mass storage device(s) 1708 to enable reading from and/or writing to the various computer readable media. Mass storage device(s) 1708 include removable media 1726 and/or non-removable media.

I/O device(s) 1710 include various devices that allow data and/or other information to be input to or retrieved from computing device 1700. Example I/O device(s) 1710 include cursor control devices, keyboards, keypads, microphones, monitors or other display devices, speakers, printers, network interface cards, modems, and the like.

Display device 1730 includes any type of device capable of displaying information to one or more users of computing device 1700. Examples of display device 1730 include a monitor, display terminal, video projection device, and the like.

Interface(s) 1706 include various interfaces that allow computing device 1700 to interact with other systems, devices, or computing environments. Example interface(s) 1706 may include any number of different network interfaces 1720, such as interfaces to local area networks (LANs), wide area networks (WANs), wireless networks, and the Internet. Other interface(s) include user interface 1718 and peripheral device interface 1722. The interface(s) 1706 may also include one or more user interface elements 1718. The interface(s) 1706 may also include one or more peripheral interfaces such as interfaces for printers, pointing devices (mice, track pad, or any suitable user interface now known to those of ordinary skill in the field, or later discovered), keyboards, and the like.

Bus 1712 allows processor(s) 1702, memory device(s) 1704, interface(s) 1706, mass storage device(s) 1708, and I/O device(s) 1710 to communicate with one another, as well as other devices or components coupled to bus 1712. Bus 1712 represents one or more of several types of bus structures, such as a system bus, PCI bus, IEEE 13174 bus, USB bus, and so forth.

For purposes of illustration, programs and other executable program components are shown herein as discrete blocks, although it is understood that such programs and components may reside at various times in different storage components of computing device 1700, and are executed by processor(s) 1702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

It will be appreciated that a system of providing optimal irrigation in an irrigation system having a controller configured to be connected to an irrigation server over a computer network may include a computer network that itself may include an irrigation server and a protocol generator. The system may further include a controller. It will be appreciated that the controller may be in electronic communication with the plumbing of the irrigation system. The controller may also be in communication with the irrigation server over the computer network. Thus, when a communication connection between the controller and the server is established information and data may be exchanged between the server and the controller. For example, the server may formulate, generate and otherwise develop an irrigation protocol and/or a historical operational backup protocol and may send one or more of those protocols to the controller.

The controller, in return, may generate a transcript or other data relating to an iteration of the irrigation or watering event that may have just occurred. The transcript or other operational data may be sent from the controller to the irrigation server and the cloud or network service.

Additionally, in an implementation data may be stored and written, such as the irrigation protocol, into computer memory of the controller and/or server. The irrigation server may receive data reported back from the controller relating to an iteration of the irrigation protocol that has been executed. The protocol generator may use the reported back data to generate a historical backup protocol. The irrigation server may send the historical backup protocol to the controller wherein the historical backup protocol may be stored or written to the computer memory of the controller. The controller may retrieve the historical backup protocol from memory and may then execute the historical protocol if or when a connection between the irrigation server and the controller is not established.

In an implementation, the controller records irrigation iteration data into computer memory after the irrigation protocol has been executed by the controller. In an implementation, the controller records irrigation iteration data into computer memory until communication between the irrigation server and controller is reestablished. In an implementation, the controller may record irrigation iteration data for a plurality of iterations into computer memory after a plurality of irrigation protocols have been executed by the controller. In an implementation, the controller may record irrigation iteration data into computer memory until communication between the irrigation server and controller is reestablished.

In an implementation, the irrigation server may initiate and receive one or more notifications that may be output from the controller regarding the connection that was not established. In an implementation, the notification may be a visual output from the controller that operates as a visual cue to a user. In an implementation, the notification may be an audible signal output from the controller that operates as an audio cue to a user.

The system and method may generate a first start time that may act as a calendar item to send a follow-up query or notification to the user, for example a week later, to determine whether the user is pleased or otherwise satisfied with the health of the landscape, and if so, the system may reduce the amount of water a second time. The system and method may generate a calendar item to send a follow-up query or notification to the user, for example a week later, to determine whether the user is pleased or otherwise satisfied with the health of the landscape. If the user is satisfied, then the system may maintain the current duration for that zone.

The weather information may include current weather information and may be for a specific location that corresponds with the location of the controller of the plumbing system. The weather information may include data relating to current humidity, current temperature, current solar radiation, and/or current wind speed. The weather information may also provide additional data without departing from the scope of the disclosure.

In an implementation, the irrigation server may aggregate weather data from a single source or from a plurality of sources. In an implementation, the system and method may include a user web account, wherein the user web account is paired with the controller. In an implementation, the system may further include a notice generator that generates notifications for a user regarding events within the system, wherein the irrigation server transmits the notifications to the user prompting the user to enter data relating to the irrigation system and/or one or more irrigation zones of the irrigation system. In an implementation, the irrigation server may electronically communicate with the user through the web account located on a database and displayed using a general purpose computer, through a mobile device, and/or through the controller to send the notifications to the user.

The cloud or network service may perform many of the calculations and generate the irrigation protocols and other instructions that may be sent directly to the controller. Thus, it is the cloud or network service that provides the processing via one or more servers of the data obtained from one or more various aggregated weather sources or databases. In an implementation, the irrigation server may perform various computer implemented steps to utilize the current weather data that is provided at a regular predetermined interval, such as at one hour intervals, and generate the irrigation protocols that may be sent to the controller for actuation of the irrigation or plumbing system.

The irrigation server may electronically communicate with the controller. The irrigation server may also send one or more irrigation protocols to the controller over the computer network where the irrigation protocol is written into computer memory of the controller for execution by the controller. In an implementation, the system and method may utilize a clock that may be configured for providing time stamp data to events within the system. The one or more irrigation protocols may include time stamp data. Once the controller has received the one or more irrigation protocols, the controller executes the irrigation protocols to thereby actuate the irrigation or plumbing system.

In an implementation, the system and method the irrigation server may determine a slope of the ground, current temperature, and/or the geographical region type if there is no solar radiation data provided to the protocol generator. In an implementation, the irrigation server determines the slope of the ground, temperature, and/or the geographical region type prior to the protocol generator determining the amount of water needed to replenish the root zone for the given irrigation zone.

In an implementation, the system and method may further include initiating a notification to a user's communication device regarding the connection that was not established. In an implementation, the user communication device may be a computing device connected over a network. In an implementation, the network may include cellular network functionality. In an implementation, the user communication device may be a mobile device or other communication device capable of receiving notifications from a network. In an implementation, the system and method may further include initiating and receiving a notification output from the controller regarding the connection that was not established. It will be appreciated that in an implementation, the notification may be a visual output from the controller. In an implementation, the notification may be an audible signal output from the controller. In an implementation, the system and method may further include rechecking for network connectivity between the irrigation server and the controller.

### EXAMPLES

The following examples pertain to further embodiments.

Example 1 is a method for determining watering times. The method includes determining a dynamic watering schedule to replenish water in a root zone for an irrigation zone. Determining the dynamic watering schedule includes dynamically calculating a watering frequency and a watering duration to replenish water in the root zone for the irrigation zone based on one or more of weather data, a time of year, or a location corresponding to the irrigation zone. The method includes controlling an irrigation system to water the irrigation zone based on the dynamic watering schedule. The method includes, in response to irrigation of the irrigation zone according to the dynamic watering schedule, receiving user input indicating a preference to increase or decrease wetness for the irrigation zone. The method includes, in response to the user input, modifying the dynamic watering schedule based on the user input to increase or decrease wet. The method further includes controlling the irrigation system to water the irrigation zone based on the dynamic watering scheduled as modified.

In Example 2, modifying the dynamic watering scheduled in Example 1 includes recalculating the watering frequency or the watering duration for the irrigation zone based on the preference and one or more of the weather data, the time of year, or the location.

In Example 3, modifying the dynamic watering schedule in any of Examples 1-2 includes, for at least some values for user input (such as values above or below a threshold value), increasing or decreasing a frequency of watering without increasing or decreasing a total watering duration within a time period.

In Example 4, modifying the dynamic watering schedule in any of Examples 1-2 includes increasing a total watering duration for the irrigation zone within a time period.

In Example 5, the method in any of Examples 1-4 further includes providing a query to the user requesting input regarding a status of the soil or plants in the irrigation zone, wherein the status indicates a wetness or health of the soil or plants.

In Example 6, the user input in any of Examples 1-5 indicates an offset value, wherein a watering coefficient or a wetness value used to calculate the dynamic watering schedule is modified based on the offset value to increase or decrease wetness of the irrigation zone.

In Example 7, the dynamic watering schedule in any of Examples 1-6 is configured to cause the irrigation system to vary one or more of the watering frequency or the watering duration for the irrigation zone over time.

In Example 8, controlling the irrigation system in any of Examples 1-7 includes providing instructions or a portion of the dynamic watering schedule to an irrigation controller.

In Example 17, dynamically calculating the watering frequency and the watering duration in any of Examples 1-8 includes periodically calculating the watering frequency and the watering duration based on current or updated values for the weather data, the time of year, or the user input.

Example 10 is an apparatus including means to perform a method of any of Examples 1-17.

Example 11 is a machine readable storage including machine-readable instructions, when executed, to implement a method or realize an apparatus of any of Examples 1-10.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

It should be understood that many of the functional units described in this specification may be implemented as one or more components, which is a term used to more particularly emphasize their implementation independence. For example, a component may be implemented as a hardware circuit comprising custom very large scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, include one or more physical or logical blocks of computer instructions, which may, for instance, be organized as an object, a procedure, or a function. Nevertheless, the executables of an identified component need not be physically located together, but may include disparate instructions stored in different locations that, when joined logically together, include the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may be embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

Implementations of the disclosure can also be used in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, or any suitable characteristic now known to those of ordinary skill in the field, or later discovered), service models (e.g., Software as a Service (SaaS), Platform as a Service (PaaS), Infrastructure as a Service (IaaS)), and deployment models (e.g., private cloud, community cloud, public cloud, hybrid cloud, or any suitable service type model now known to those of ordinary skill in the field, or later discovered). Databases and servers described with respect to the disclosure can be included in a cloud model.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

What is claimed is:

1. An irrigation schedule control system comprising:
a schedule component configured to determine a dynamic watering schedule to replenish water in a root zone for an irrigation zone, wherein determining the dynamic watering schedule comprises dynamically calculating a watering frequency and a watering duration to replenish water in the root zone for the irrigation zone based on one or more of weather data, a time of year, or a location corresponding to the irrigation zone;
a control component configured to control an irrigation system to water the irrigation zone based on the dynamic watering schedule;
a wetness feedback component configured to, in response to irrigation of the irrigation zone according to the dynamic watering schedule, receive user input indicating a preference to increase or decrease wetness for the irrigation zone; and
an update component configured to, in response to the user input, modify the dynamic watering schedule based on the user input to increase or decrease wetness for the irrigation zone.

2. The irrigation schedule control system of claim 1, wherein the update component is configured to modify the dynamic watering scheduled by recalculating the watering frequency or the watering duration to provide to replenish the root zone for the irrigation zone based on the preference and one or more of the weather data, the time of year, or the location.

3. The irrigation schedule control system of claim 1, wherein the update component is configured to modify the dynamic watering schedule by increasing a frequency of watering without increasing a total watering duration within a time period.

4. The irrigation schedule control system of claim 1, wherein the update component is configured to modify the dynamic watering schedule by increasing a total watering duration for the irrigation zone over a time period.

5. The irrigation schedule control system of claim 1, further comprising a query component configured to provide a query to the user requesting input regarding a status of the soil or plants in the irrigation zone, wherein the status indicates a wetness or health of the soil or plants.

6. The irrigation schedule control system of claim 1, wherein the user input indicates an offset value, wherein the update component is configured to modify a watering coefficient or a wetness value used to calculate the dynamic watering schedule is modified based on the offset value to increase or decrease wetness of the irrigation zone.

7. The irrigation schedule control system of claim 1, wherein the schedule component is configured to determine a dynamic watering schedule that causes the irrigation system to vary, over time, one or more of the watering frequency or the watering duration for the irrigation zone.

8. The irrigation schedule control system of claim 1, wherein the control component is configured to control the irrigation system by providing instructions or a portion of the dynamic watering schedule to an irrigation controller of the irrigation system to water the irrigation zone.

9. The irrigation schedule control system of claim 1, wherein the schedule component is configured to dynamically calculate the watering frequency and the watering duration by periodically calculating the watering frequency and the watering duration based on current or updated values for the weather data, the time of year, or the user input.

10. A method comprising:
determining a dynamic watering schedule to replenish water in a root zone for an irrigation zone, wherein determining the dynamic watering schedule comprises dynamically calculating a watering frequency and a watering duration to replenish water in the root zone for the irrigation zone based on one or more of weather data, a time of year, or a location corresponding to the irrigation zone;
controlling an irrigation system to water the irrigation zone based on the dynamic watering schedule;
in response to irrigation of the irrigation zone according to the dynamic watering schedule, receiving user input indicating a preference to increase or decrease wetness for the irrigation zone;
in response to the user input, modifying the dynamic watering schedule based on the user input to increase or decrease wet; and
controlling the irrigation system to water the irrigation zone based on the dynamic watering scheduled as modified.

11. The method of claim 10, wherein modifying the dynamic watering scheduled comprises recalculating the watering frequency or the watering duration for the irrigation zone based on the preference and one or more of the weather data, the time of year, or the location.

12. The method of claim 10, wherein modifying the dynamic watering schedule comprises increasing a frequency of watering without increasing a total watering duration within a time period.

13. The method of claim 10, wherein modifying the dynamic watering schedule comprises increasing a total watering duration for the irrigation zone within a time period.

14. The method of claim 10, further comprising providing a query to the user requesting input regarding a status of the soil or plants in the irrigation zone, wherein the status indicates a wetness or health of the soil or plants.

15. The method of claim 10, wherein the user input indicates an offset value, wherein a watering coefficient or a wetness value used to calculate the dynamic watering schedule is modified based on the offset value to increase or decrease wetness of the irrigation zone.

16. The method of claim 10, wherein the dynamic watering schedule is configured to cause the irrigation system to vary one or more of the watering frequency or the watering duration for the irrigation zone over time.

17. The method of claim 10, wherein controlling the irrigation system comprises providing instructions or a portion of the dynamic watering schedule to an irrigation controller.

18. The method of claim 10, wherein dynamically calculating the watering frequency and the watering duration comprises periodically calculating the watering frequency and the watering duration based on current or updated values for the weather data, the time of year, or the user input.

19. Computer readable storage media storing instructions that, when executed by one or more processors, cause the processors to:
determine a dynamic watering schedule to replenish water in a root zone for a irrigation zone, wherein determining the dynamic watering schedule comprises dynamically calculating a watering frequency and a watering duration to replenish water in the root zone for the irrigation zone based on one or more of weather data, a time of year, or a location corresponding to the irrigation zone;
control an irrigation system to water the irrigation zone based on the dynamic watering schedule;
in response to irrigation of the irrigation zone according to the dynamic watering schedule, receive user input indicating a preference to increase or decrease wetness for the irrigation zone; and
in response to the user input, modify the dynamic watering schedule based on the user input to increase or decrease wet.

20. The computer readable storage media of claim 19, wherein modifying the dynamic watering scheduled comprises recalculating the watering frequency or the watering duration for the irrigation zone based on the preference and one or more of the weather data, the time of year, or the location.

21. The computer readable storage media of claim 19, wherein modifying the dynamic watering schedule comprises increasing a frequency of watering without increasing a total watering duration within a time period.

22. The computer readable storage media of claim 19, wherein modifying the dynamic watering schedule comprises increasing a total watering duration for the irrigation zone within a time period.

23. The computer readable storage media of claim 19, further storing instructions that cause the processors to provide a query to the user requesting input regarding a status of the soil or plants in the irrigation zone, wherein the status indicates a wetness or health of the soil or plants.

24. The computer readable storage media of claim 19, wherein the user input indicates an offset value, wherein modifying the dynamic watering schedule comprises modifying a watering coefficient or a wetness value used to calculate the dynamic watering schedule based on the offset value to increase or decrease wetness of the irrigation zone.

25. The computer readable storage media of claim 19, wherein the dynamic watering schedule causes the irrigation system to vary one or more of the watering frequency or the watering duration for the irrigation zone over time.

26. The computer readable storage media of claim 19, wherein controlling the irrigation system comprises providing instructions or a portion of the dynamic watering schedule to an irrigation controller.

27. The computer readable storage media of claim 19, wherein dynamically calculating the watering frequency and the watering duration comprises periodically calculating the watering frequency and the watering duration based on current or updated values for the weather data, the time of year, or the user input.
